(19) United States
(12) Patent Application Publication
(10) Pub. No.: US 2019/0299389 A1
(43) Pub. Date: Oct. 3, 2019

(54) HAND TOOL ADAPTER

(71) Applicant: Chung-Yu Tsai, Taichung (TW)

(72) Inventor: Chung-Yu Tsai, Taichung (TW)

(21) Appl. No.: 15/939,321

(22) Filed: Mar. 29, 2018

(51) Int. Cl. B25G 1/10; B25B 15/00; B25B 23/00

(52) U.S. Cl. CPC B25G 1/102; B25B 23/0007; B25B 15/008

(57) ABSTRACT

A hand tool adapter includes a first body and a second body in which the first body is received. The first body includes multiple first recesses and multiple first receiving portions formed on the outer surface thereof. The first receiving portions each protruded from the first body. Each of the first receiving portion has a polygonal first engaging bore or a polygonal second engaging bore defined therein. The second body includes multiple second recesses and multiple second receiving portions formed on the outer surface thereof. The second recesses receive the first receiving portions respectively. The second receiving portions are received in the first recesses respectively.

### BACKGROUND OF THE INVENTION

### 1. Fields of the Invention

The present invention relates to a hand tool adapter, and more particularly, to a hand tool adapter that includes multiple engaging bores for being cooperated with other tools.

### 2. Descriptions of Related Art

The conventional hand tool adapter known to applicant is disclosed in U.S. Pat. No. 8,261,638 and comprises a plastic main body having at least six holes. At least six metallic sockets are fixedly received in one of the holes respectively. Each socket defines a non-circular bore, and each bore has an axial vector. The axial vectors of the bores are different from one another. Each bore has a dimension different from those of the other bores so as to be connected with screws and other hand tools.

However, the number of the holes formed in the outer surface of the main body is limited, no matter the main body is a sphere body or includes six faces. In other words, the limited holes restrict the use of the screws or hand tools that are connected to the main body. The holes of the main body are designed to be connected with the sockets, and this means that more adapters to be connected with the sockets are required. This requirement increases the cost of the users. Besides, sockets are required to be snugly engaged with the holes, so that the manufacturing of the adapter requires more precise machining.

The present invention intends to provide a hand tool adapter to eliminate the shortcomings mentioned above.

### SUMMARY OF THE INVENTION

The present invention relates to a hand tool adapter and comprises a first body and a second body in which the first body is received. The first body includes multiple first recesses and multiple first receiving portions formed on the outer surface thereof. The first receiving portions each protruded from the first body. Each of the first receiving portion has a polygonal first engaging bore or a polygonal second engaging bore defined therein. The second body includes multiple second recesses and multiple second receiving portions formed on the outer surface thereof. The second recesses receive the first receiving portions respectively. The second receiving portions are received in the first recesses respectively.

The second body is received in the first body to form the adapter, wherein the second receiving portions are received in the first recesses 11 respectively, and the first receiving portions are received in the second recesses so that the adapter includes multiple hexagonal first receiving portions and multiple pentagonal second receiving portions.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the hand tool adapter of the present invention;

FIG. 2 is a perspective view to show the hand tool adapter of the present invention;

FIG. 3 is a side view to show the hand tool adapter of the present invention;

FIG. 4 is a cross sectional view, taken along line 4-4 in FIG. 3;

FIG. 5 is an operative status of the hand tool adapter of the present invention, and

FIG. 6 is a perspective view to show another embodiment of the hand tool adapter of the present invention.

### DETAILED DESCRIPTION OF THE PREFERRED EMBODIMENT

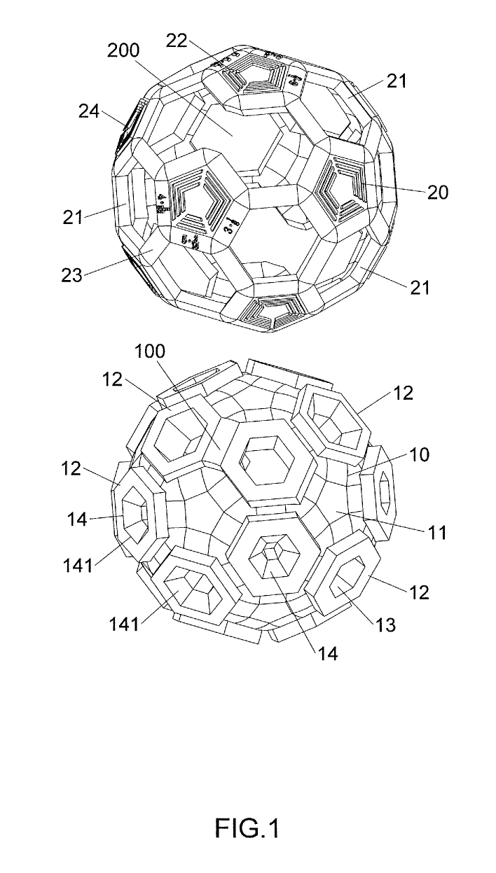

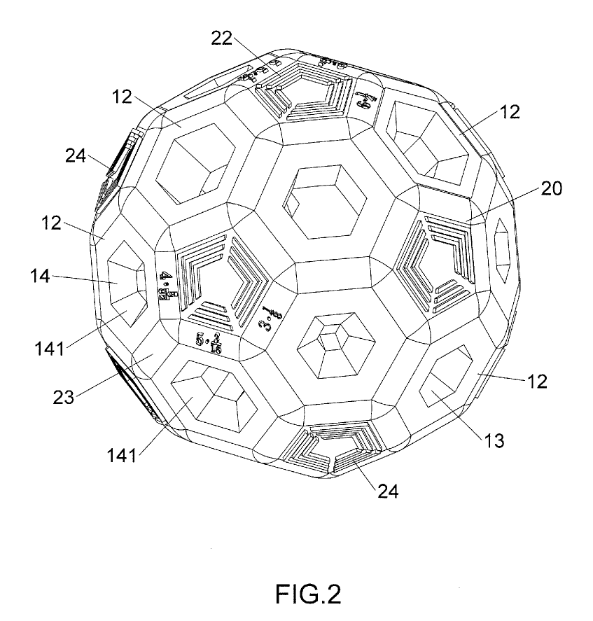

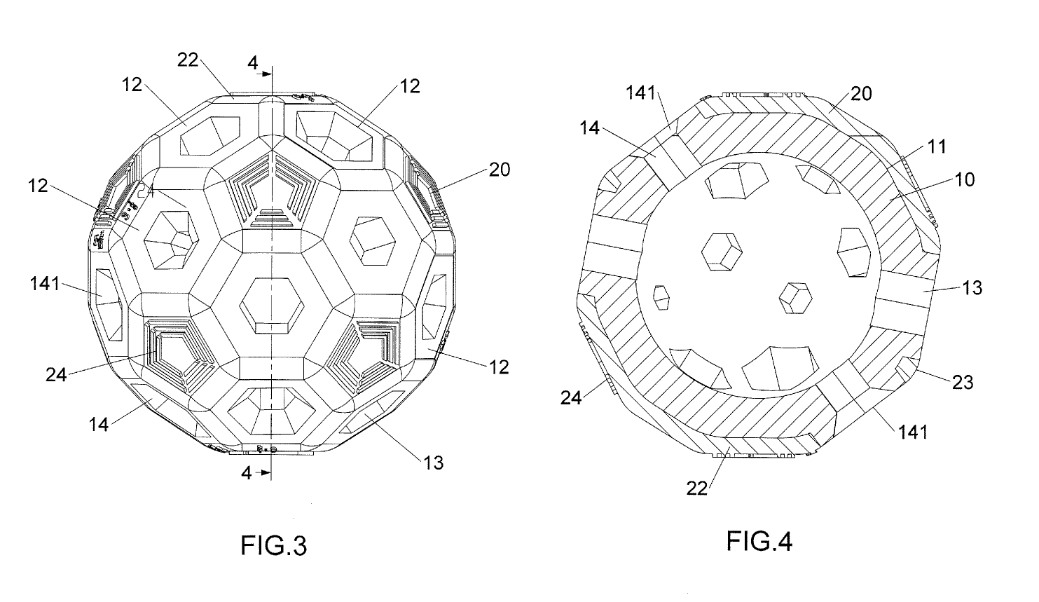

Referring to FIGS. 1 to 5, the hand tool adapter of the present invention comprises a first body 10 which is a spherical body and comprises multiple first recesses 11 and multiple first receiving portions 12 formed on the outer surface thereof. The first recesses 11 are arranged diametrically opposite to each other. The first receiving portions 12 are arranged diametrically opposite to each other. The first receiving portion 12 protrude from the outer surface of the first body 10 and are located around each first recess 11. A distance is formed between adjacent first receiving portions 12. Each first recess 11 is a pentagonal recess, and each first receiving portion 12 has a hexagonal wall extending therefrom which includes a hexagonal outside and a hexagonal inside. The first body 10 includes multiple pentagonal portions and multiple hexagonal portions. Some of the first receiving portions 12 have a polygonal first engaging bore 13 defined therein, and some of the first receiving portions 12 have a polygonal second engaging bore 14 defined therein. Each of two of the first receiving portions 12 that are located diametrically opposite to each other has an identical polygonal first engaging bore 13 or polygonal second engaging bore 14 which has different specification from that of the polygonal first engaging bore 13. In other words, there are multiple pairs of polygonal first engaging bores 13 are located diametrically opposite to each other, and multiple pairs of polygonal second engaging bores 14 are located diametrically opposite to each other. The polygonal first engaging bores 13 are hexagonal Metric-system bores. The polygonal second engaging bores 14 are hexagonal English-system bores.

A second body 20 receives the first body 10 therein. The second body 20 is a hollow case and the first body 10 is put in the molding unit for the second body 20 so that when the second body 20 is formed by way of injection molding, the first body 10 is received in the second body 20. The second body 20 has multiple second recesses 21 and multiple second receiving portions 22 formed on the outer surface thereof. The second recesses 21 are arranged diametrically opposite to each other. The second receiving portions 22 are arranged diametrically opposite to each other. The second recesses 21 are located around each second receiving portion 22, and each second recess 21 is a hexagonal recess. Each second receiving portion 22 is a solid pentagonal portion protruding from the outer surface of the second body 20. In other words, the second body 20 also includes multiple pentagonal portions and multiple hexagonal portions. The second recesses 21 receive the first receiving portions 12 respectively, and the second receiving portions 22 are received in the first recesses 11 respectively. The opening of the second recess 21 is in flush with the top face of the first receiving portion 12 corresponding thereto. A connection portion 23 is connected between any two adjacent second recesses 21. Also, the connection portion 23 is located between adjacent first receiving portions 12. Each of the connection portions 23 is a protruded and curved portion, and has marks for disclosing specification of the first and second engaging bores 13, 14. The second receiving portions 22 each have patterns 24 protruding therefrom which include multiple strips for providing proper friction when the user holds the adapter. After the first and second bodies 10, 20 are connected to each other, the adapter includes multiple hexagonal first receiving portions 12 and multiple pentagonal second receiving portions 22. The stiffness of the first body 10 is harder than that of the second body 20 which is suitable for being held by the users.

As shown in FIGS. 1 to 5, at least two adjacent second recesses 21 communicate with each other by a path 200, and at least two adjacent first receiving portions 12 are connected to each other by a ridge 100. The ridge 100 is engaged with the path 200. The first recesses 11 and the first receiving portions 12 are located on an axis of each face of a dodecahedron, an octahedron, an icosahedron.

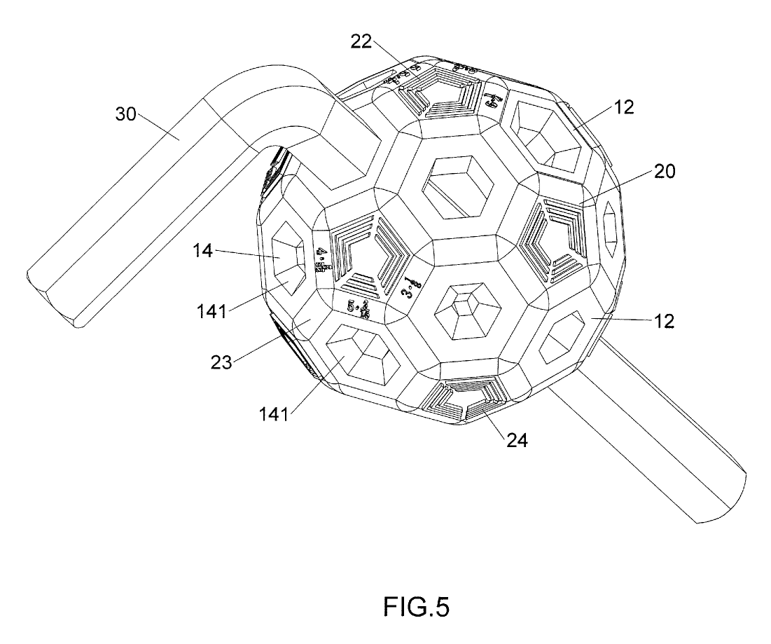

As shown in FIG. 5, at least one hand tool 30 extends through the second recesses 21 of the second body 20 so that the user may hold the first and second bodies 10, 20 to rotate the at least one hand tool 30. In this embodiment, the at least one hand tool 30 is a hexagonal wrench.

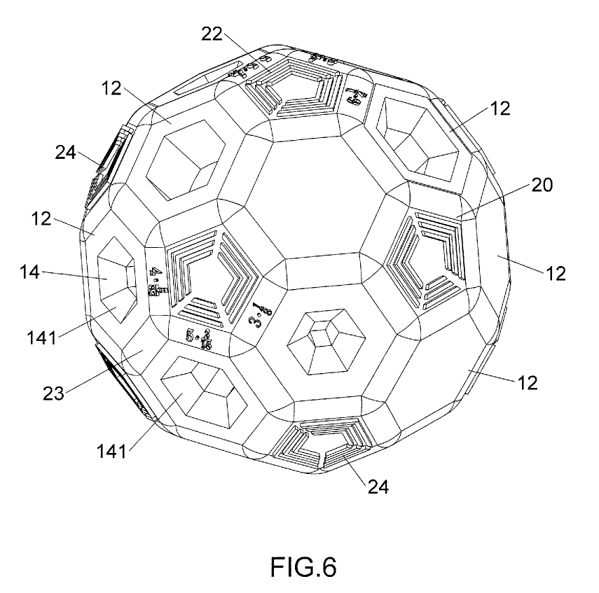

As shown in FIG. 6, in this embodiment, all of the first receiving portions 12 each have one first engaging bore 13 defined therein, or all of the first receiving portions 12 each have one second engaging bore 14 defined therein.

The advantages of the present invention are that the adapter includes multiple hexagonal first receiving portions 12 and multiple pentagonal second receiving portions 22 so as to provide more features.

Some of the first receiving portions 12 have one Metric-system first engaging bore 13 defined therein, and some of the first receiving portions 12 each have one English-system second engaging bore 14 defined therein. The adapter can be cooperated with the hand tool 30 of different systems.

The manufacturing processes for making the adapter is easy.

The at least one hand tool 30 extends through the second recesses 21 of the second body 20 so that the user may hold the first and second bodies 10, 20 to rotate the at least one hand tool 30.

The second body 20 is made by soft material which is suitable for being held by the users.

The outer surface of the adapter has multiple hexagonal first receiving portions 12 and multiple pentagonal second receiving portions 22 so that even if the adapter falls to the ground, the adapter does not roll away.

While we have shown and described the embodiment in accordance with the present invention, it should be clear to those skilled in the art that further embodiments may be made without departing from the scope of the present invention.

What is claimed is:

1. A hand tool adapter comprising:
a first body being a spherical body and having multiple first recesses and multiple first receiving portions formed on an outer surface thereof, the first recesses being arranged diametrically opposite to each other, the first receiving portions being arranged diametrically opposite to each other, the first receiving portion located around each first recess, each first recess being a pentagonal recess, each first receiving portion having a hexagonal wall extending therefrom which includes a hexagonal outside and a hexagonal inside, each of the first receiving portions having a polygonal first engaging bore or a polygonal second engaging bore defined therein, each of two of the first receiving portions located diametrically opposite to each other having an identical polygonal first engaging bore or polygonal second engaging bore which has different specification from that of the polygonal first engaging bore, and
a second body receiving the first body therein, the second body having multiple second recesses and multiple second receiving portions formed on an outer surface thereof, the second recesses being arranged diametrically opposite to each other, the second receiving portions being arranged diametrically opposite to each other, the second recesses located around each second receiving portion, each second recess being a hexagonal recess, each second receiving portion being a pentagonal portion, the second recesses receiving the first receiving portions respectively, the second receiving portions being received in the first recesses respectively so that the adapter includes multiple hexagonal first receiving portions and multiple pentagonal second receiving portions, the first body adapted to be put in a molding unit for the second body so that when the second body is formed, the first body is received in the second body.

2. The adapter as claimed in claim 1, wherein the first engaging bores are Metric-system bores, and the second engaging bores are English-system bores.

3. The adapter as claimed in claim 1, wherein the second engaging bores each have inclined faces which are adapted to guide hand tools to be engaged with the second engaging bores, the first engaging bores do have the inclined faces.

4. The adapter as claimed in claim 1, wherein a connection portion is connected between any two adjacent second recesses, each of the connection portions is a protruded and curved portion and has marks for disclosing specification of the first and second engaging bores, the second receiving portions each have patterns protruding therefrom which include multiple strips.

5. The adapter as claimed in claim 1, wherein a stiffness of the first body is harder than that of the second body.

6. The adapter as claimed in claim 1, wherein at least one hand tool extends through the second recesses of the second body, the at least one hand tool is a hexagonal wrench.

7. The adapter as claimed in claim 1, wherein the first receiving portions of the first body each do not have the first engaging bore or the second engaging bore.

8. The adapter as claimed in claim 1, wherein each of the first receiving portions has one first engaging bore defined therein.

9. The adapter as claimed in claim 1, wherein each of the first receiving portions has one second engaging bore defined therein.

10. The adapter as claimed in claim 1, wherein at least two adjacent second recesses communicate with each other by a path, at least two adjacent first receiving portions are connected to each other by a ridge.

11. The adapter as claimed in claim 1, wherein the first recesses and the first receiving portions are located on an axis of each face of a dodecahedron, an octahedron, an icosahedron.

12. The adapter as claimed in claim 1, wherein an opening of the second recess is in flush with a top face of the first receiving portion corresponding thereto.
